(19) United States
(12) Patent Application Publication
(10) Pub. No.: US 2025/0207218 A1
(43) Pub. Date: Jun. 26, 2025

(54) PHASE CHANGE SYSTEM WITH MODULAR CRUCIBLES AND FLOW CONTROL NOZZLES

(71) Applicant: SHINE Technologies, LLC, Janesville, WI (US)

(72) Inventors: Zachary Childs, Madison, WI (US); Kenneth Kearney, Verona, WI (US); Eric Van Abel, Lino Lakes, MN (US); Matthew Szymski, Monona, WI (US)

(73) Assignee: SHINE Technologies, LLC, Janesville, WI (US)

(21) Appl. No.: 18/987,554

(22) Filed: Dec. 19, 2024

Related U.S. Application Data
(60) Provisional application No. 63/612,970, filed on Dec. 20, 2023.

(51) Int. Cl. C22B 5/16; C22B 4/08; C22B 59/00

(52) U.S. Cl. CPC C22B 5/16; C22B 4/08; C22B 59/00

(57) ABSTRACT

A phase change system comprising a reduction assembly, a cold sublimation assembly, and a hot sublimation assembly. The reduction assembly comprises a reduction crucible, a first modular crucible, and a reduction control nozzle and, when assembled, the reduction control nozzle is positioned between an open end of the reduction crucible and an open end of the first modular crucible and a protruding outlet of the reduction control nozzle extends into an activity chamber of the first modular crucible. The cold sublimation assembly comprises a collection crucible and a cold sublimation control nozzle and, when assembled, the cold sublimation control nozzle extends into an activity chamber of the collection crucible. In addition, the hot sublimation assembly comprises a hot sublimation crucible and a second modular crucible and, when assembled, the hot sublimation crucible is fluidly coupled to the second modular crucible.

### CROSS-REFERENCE TO RELATED APPLICATIONS

This application claims the benefit of U.S. Provisional Application No. 63/612,970 filed on Dec. 20, 2023, which is incorporated herein by reference in its entirety.

### TECHNOLOGY

The present disclosure is generally related to phase change systems. More particularly, the present disclosure is directed to phase change systems for the accumulation of target radioisotopes.

### BACKGROUND

Lutetium-177 (Lu-177) is a radioisotope that is used in the treatment of neuro endocrine tumors, prostate, breast, renal, pancreatic, and other cancers. In the coming years, approximately 70,000 patients per year will need Lu-177 during their medical treatments.

Accordingly, a need exists for improved techniques of separating and purifying radioisotopes, such as Lu-177.

### SUMMARY

According to one embodiment of the present disclosure, a phase change system includes a reduction assembly, a cold sublimation assembly, and a hot sublimation assembly, wherein: the reduction assembly comprises a reduction crucible, a first modular crucible, and a reduction control nozzle and, when assembled, the reduction control nozzle is positioned between an open end of the reduction crucible and an open end of the first modular crucible and a protruding outlet of the reduction control nozzle extends into an activity chamber of the first modular crucible; the cold sublimation assembly comprises a collection crucible and a cold sublimation control nozzle and, when assembled, the cold sublimation control nozzle extends into an activity chamber of the collection crucible; and the hot sublimation assembly comprises a hot sublimation crucible and a second modular crucible and, when assembled, the hot sublimation crucible is fluidly coupled to the second modular crucible.

According to another embodiment of the present disclosure, a method includes heating a powder mixture comprising a rare earth oxide powder and a lanthanum powder in a reduction crucible, wherein heating the powder mixture reduces the rare earth oxide powder into a rare earth metal composition that collects in a first modular crucible, wherein the rare earth metal composition comprises a rare earth metal and a lanthanum metal; positioning the first modular crucible on a crucible heater while the rare earth metal composition is disposed in the first modular crucible; fluidly coupling the first modular crucible to a collection crucible using a sublimation control nozzle, such that the sublimation control nozzle is positioned between the first modular crucible and the collection crucible, the sublimation control nozzle comprising a flow channel; and heating the first modular crucible using the crucible heater, thereby heating the rare earth metal composition and phase separating the rare earth metal from the lanthanum metal leaving a higher weight percentage of the of the lanthanum metal in the first modular crucible than was present in the rare earth metal composition and collecting a refined rare earth element composition in a collection crucible, wherein the refined rare earth element composition comprises a higher weight percentage of the rare earth metal than the rare earth metal composition.

According to yet another embodiment of the present disclosure, a phase change system includes a reduction assembly, a cold sublimation assembly, and a hot sublimation assembly, wherein: the reduction assembly comprises a reduction crucible, a first modular crucible, and a reduction control nozzle and, when assembled, the reduction control nozzle is positioned between an open end of the reduction crucible and an open end of the first modular crucible; the hot sublimation assembly comprises a hot sublimation crucible and a second modular crucible comprising an open end and, when assembled, the hot sublimation crucible is fluidly coupled to the second modular crucible; and the cold sublimation assembly comprises a collection crucible and a sublimation control nozzle and, when assembled, the sublimation control nozzle is positioned between an open end of the collection crucible and the open end of the first modular crucible or the open end of the second modular crucible.

According to yet another embodiment of the present disclosure, a phase change system includes a reduction assembly, a cold sublimation assembly, and a hot sublimation assembly, wherein: the reduction assembly comprises a reduction crucible, a first modular crucible, and a reduction control nozzle; the reduction control nozzle comprises a flow channel configured to be positioned between an open end of the reduction crucible and an open end of the first modular crucible such that the flow channel fluidly couples the reduction crucible and the first modular crucible; the hot sublimation assembly comprises a hot sublimation crucible and a second modular crucible; the cold sublimation assembly comprises a collection crucible, a sublimation control nozzle, and one of the first modular crucible, the second modular crucible, or a third modular crucible; and the sublimation control nozzle comprises a flow channel is configured to be positioned between an open end of the one of the first modular crucible, the second modular crucible, or the third modular crucible, and an open end of the collection such that the flow channel fluidly couples the collection crucible and the one of the first modular crucible, the second modular crucible, or the third modular crucible.

According to yet another embodiment of the present disclosure, an assembly includes a first modular crucible and a second modular crucible, each comprising: an open end opposite a closed end; a crucible body; an activity chamber; and an end shoulder comprising an interfacing edge terminating at the open end; and a sublimation control nozzle comprising a nozzle body and a flow channel extending through the nozzle body from an inlet opening to an outlet opening, the nozzle body comprising an edge extension positioned radially outward the flow channel wherein: the sublimation control nozzle is positioned between the open end of the first modular crucible and the second modular crucible, fluidly coupling the first modular crucible and the second modular crucible; and the edge extension of the sublimation control nozzle engages the interfacing edge of the first modular crucible, forming a tortious interface between the sublimation control nozzle and the first modular crucible.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a phase change system that includes a reduction assembly, a cold sublimation assembly and a hot sublimation assembly, according to one or more embodiments shown and described herein;

FIG. 2 depicts a detailed view of the reduction assembly of FIG. 1, according to one or more embodiments shown and described herein;

FIG. 3 depicts a detailed view of the cold sublimation assembly of FIG. 1, according to one or more embodiments shown and described herein;

FIG. 4 depicts a detailed view of the hot sublimation assembly of FIG. 1, according to one or more embodiments shown and described herein;

FIG. 5 depicts a partial view of a modular crucible and a sublimation control nozzle, according to one or more embodiments shown and described herein;

FIG. 6 depicts a crucible heater, according to one or more embodiments shown and described herein; and

FIG. 7 depicts a hot sublimation crucible, according to one or more embodiments shown and described herein.

### DETAILED DESCRIPTION

Referring generally to the figures, embodiments of the present disclosure are directed to a phase change system for the accumulation of a target radioisotope, such as a target rare earth radioisotope, for example, lutetium-177 (“Lu-177”). Accumulation of the target radioisotope using the phase change system includes the reduction of rare earth metal oxides into rare earth metals and the separation of rare earth metals by sublimation, distillation, or a combination thereof, for example, the separation of ytterbium from a composition that comprises ytterbium and lutetium, thereby accumulating lutetium. The phase change system includes a reduction assembly, a cold sublimation assembly, and a hot sublimation assembly. The reduction assembly is configured to support the reduction of a rare earth metal oxide into a rare earth metal. The cold sublimation assembly is configured to support the purification of a rare earth metal, for example, a non-radioactive rare earth metal (i.e., is radioactively “cold”), by sublimation or distillation. The hot sublimation assembly is configured to support separation of a first rare earth metal from a solid composition comprising a first rare earth metal and a second rare earth metal, where the solid composition is radioactive (i.e., is radioactively “hot”). The phase change system includes multiple modular crucibles, which may be used throughout the phase change system as both reaction crucibles (i.e., crucibles where a reduction or separation reaction occurs) and collection crucibles (i.e., crucibles where a reduction or separation product is collected). This modularity minimizes material loss due to transfer and provides additional flexibility in the phase change system. Moreover, this provides redundancy of parts, increasing the resiliency of the process.

The modular crucibles of the phase change system facilitate multiple uses of the cold sublimation assembly. For example, a modular crucible may operate as a collection crucible in the reduction assembly, collecting a rare earth metal that underwent reduction, and then used as the sublimation crucible in the cold sublimation assembly, where the rare earth metal may be purified via a sublimation or distillation process before it undergoes irradiation. Similarly, a modular crucible may operate as a collection crucible in a hot sublimation assembly, collecting a separated rare earth element, that is separated from a target rare earth element in a hot sublimation crucible. The hot sublimation assembly configured to support separation of a second element (such as ytterbium) from a composition comprising a first element (such as lutetium) and the second element and collection of both the first element and the second element with minimal loss of either. For example, this separation may occur by sublimating or distilling the second element from the composition and collecting both the sublimated second element and a remaining first element. The remaining first element may compromise high purity isotopes of lutetium, such as Lu-177 separated from a composition comprising ytterbium and lutetium. The modular crucible with the separated second element, such as ytterbium, then undergoes a waiting period, while any radioactive material in the separated rare earth element decays. Thereafter, the modular crucible is sent back to the cold sublimation assembly, where it operates as a sublimation crucible in the cold sublimation assembly, where the separated second element is purified via a sublimation process before it undergoes another round of irradiation. Thus, the phase change system facilitates the collection of a target rare earth element, such as lutetium, for example Lu-177, while also facilitating the recycling and reuse of the separated rare earth element, such as ytterbium, for example, ytterbum-176 (Yb-176), which may then be used to generate more of the target radioisotope.

Indeed, the modularity and the component design (such as the crucibles and the flow control nozzles) of each assembly of the phase change system (i.e., the reduction assembly, the cold sublimation assembly, and the hot sublimation assembly) minimizes loss of ytterbium during the reduction process and the cold separation process and minimizes the loss of both lutetium and ytterbium (in both their separated compositional form and a combined compositional form) during the hot separation process, which are rare and expensive materials. This allows the lutetium and ytterbium to be reprocessed with minimal loss, and used to collect additional high purity lutetium, such as additional Lu-177.

Lu-177 is used in the treatment of neuro endocrine tumors, prostate, breast, renal, pancreatic, and other cancers. In the coming years, approximately 70,000 patients per year will need no carrier added Lu-177 during their medical treatments. Lu-177 is useful for many medical applications, because during decay it emits a low energy beta particle that is suitable for treating tumors. It also emits two gamma rays that can be used for diagnostic testing. Isotopes with both treatment and diagnostic characteristics are termed “theranostic.” Not only is Lu-177 theranostic, but it also has a 6.65-day half-life, which allows for more complicated chemistries to be employed, as well as allowing for easy global distribution. Lu-177 also exhibits chemical properties that allow for binding to many bio molecules, for use in a wide variety of medical treatments.

There are two main production pathways to produce Lu-177. One is via a neutron capture reaction on Lu-176; Lu-176 (n,γ) Lu-177. This production method is referred to as carrier added (ca) Lu-177. A carrier is an isotope(s) of the same element (Lu-176 in this case), or similar element, in the same chemical form as the isotope of interest. In microchemistry the chemical element or isotope of interest does not chemically behave as expected due to extremely low concentrations. Moreover, isotopes of the same element cannot be chemically separated, and require mass separation techniques. The carrier method, therefore, results in the produced Lu-177 having limited medical application.

The second production method for Lu-177 is a neutron capture reaction on ytterbium-176 (Yb-176) (Yb-176 (n,γ) Yb-177) to produce Yb-177. Yb-177 then rapidly (t_{1/2} of 1.911 hours) beta-decays into Lu-177. This process is considered a “no carrier added” process. The process may be carried out as ytterbium metal or ytterbium oxide. The phase change system described herein which may be used for the separation of ytterbium and lutetium obtained from a no carrier added process. While the phase change system is primarily described herein in relation to the separation of ytterbium and lutetium, it should be understood that the phase change system may be used to facilitate separation of a variety of elements, for example any of the rare earth, and/or actinide metals where there is a difference in boiling/sublimation point, such as cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

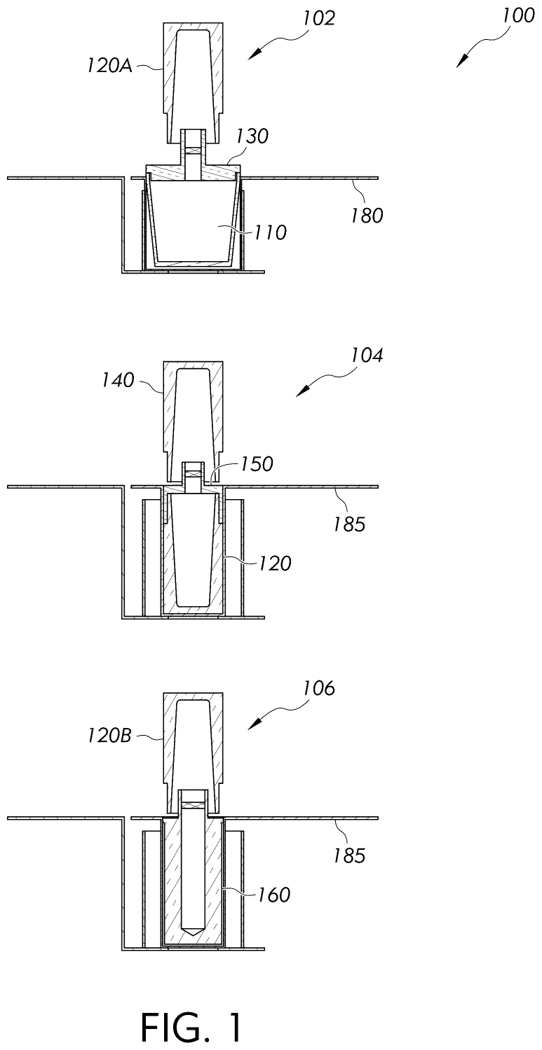

Referring now to FIG. 1, a phase change system 100 comprising a reduction assembly 102, a cold sublimation assembly 104, and a hot sublimation assembly 106 is depicted. The reduction assembly 102 comprises a reduction crucible 110, a modular crucible 120 (e.g., a first modular crucible 120A), and a reduction control nozzle 130. The hot sublimation assembly 106 comprises a hot sublimation crucible 160 and a modular crucible 120 (e.g., a second modular crucible 120B). The cold sublimation assembly comprises a collection crucible 140, a modular crucible 120 (e.g., the first modular crucible 120A of the reduction assembly 102, the second modular crucible 120B of the hot sublimation assembly 106, or another modular crucible 120) and a sublimation control nozzle 150.

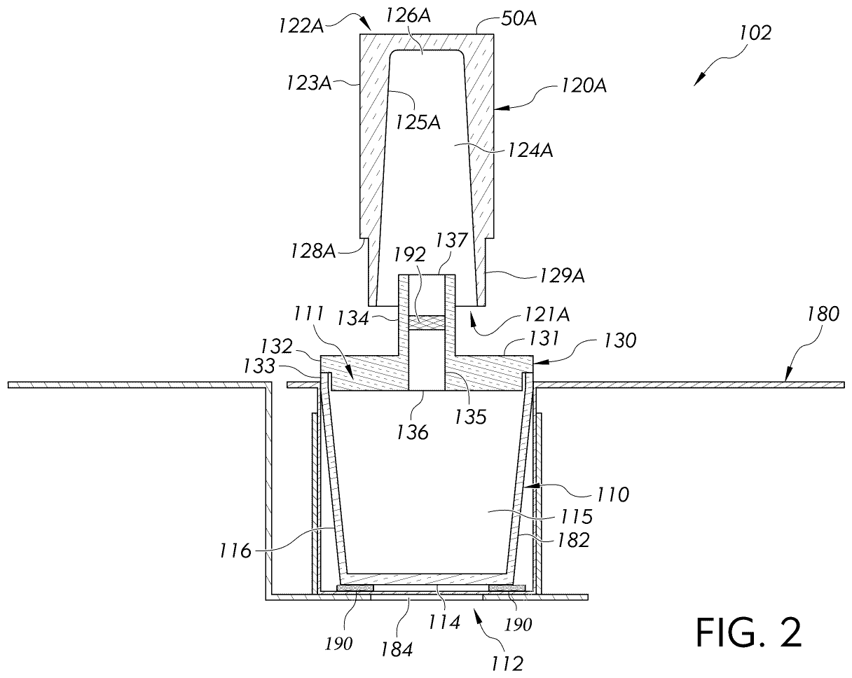

Referring now to FIG. 2, the reduction assembly 102 is depicted as assembled. The reduction assembly 102 may be assembled and disassembled. As shown in FIG. 2, when assembled, the reduction control nozzle 130 is positioned between an open end 111 of the reduction crucible 110 and an open end 121A of the first modular crucible 120A, fluidly coupling the reduction crucible 110 to the first modular crucible 120A. The reduction crucible 110 comprises an open end 111 opposite a closed end 112 and a base surface 114 located at the closed end 112. The reduction crucible 110 has a crucible body 116 and a reduction chamber 115 in the crucible body 116. The reduction chamber 115 is a chamber in which material may be located and undergo a reduction process. The reduction control nozzle 130 comprises a nozzle body 131 and a flow channel 135 extending through the nozzle body 131 from an inlet opening 136 to an outlet opening 137. The nozzle body 131 further comprises a protruding outlet 134 extending outwards from the remainder of the nozzle body 131, for example, in an upwards direction. The flow channel 135 is positioned such that the outlet opening 137 is located at the protruding outlet 134.

The first modular crucible 120A comprises a closed end 122A opposite the open end 121A and a crucible body 123A. The crucible body 123A comprises an activity chamber 124A, which is a chamber in which material may be collected and, in some embodiments, reacted. The activity chamber 124A includes an activity surface 125A. A portion of the activity surface 125A forms an activity floor 126A, which is the portion of the activity surface 125A at the closed end 122A of the first modular crucible 120A. When assembled, the protruding outlet 134 of the reduction control nozzle 130 extends into the activity chamber 124A of the first modular crucible 120A. This positions the outlet opening 137 within the activity chamber 124A of the first modular crucible 120A, minimizing loss of fluid (e.g., vaporized rare earth metal, such as vaporized ytterbium) when transferring from the reduction crucible 110 to the first modular crucible 120A during the reduction process, maximizing total mass recovery of the rare earth metal.

Referring still to FIG. 2, the reduction assembly 102 further comprises a crucible heater 180. The crucible heater 180 includes a crucible receiving recess 182 terminating at a heater base 184. In some embodiments, the crucible heater 180 is a resistive heater. However, it should be understood that other types of heaters are contemplated, for example, inductive heaters. When the reduction assembly 102 is assembled, the reduction crucible 110 is positioned in the crucible receiving recess 182 of the crucible heater 180. In some embodiments, a non-conductive washer 190 is positioned between the base surface 114 of the reduction crucible 110 and the heater base 184, for example, embodiments in which the crucible heater 180 is a resistive heater. The non-conductive washer 190 separates the reduction crucible 110 from contacting the heater base 184. In operation, when current is flowing through the crucible heater 180 and thereby generating heat to heat the reduction crucible 110, the non-conductive washer blocks current flow from the heater base 184 of the crucible heater 180 to the base surface 114 of the reduction crucible 110. In addition, the electrical break provided by the non-conductive washer 190 facilitates the use of resistance temperature detectors (RTDs) and thermocouples to measure temperature because current flow through the reduction crucible 110 would cause signal interference for the RTDs and thermocouples. In some embodiments, the non-conductive washer 190 comprises a felt material. In some embodiments, the non-conductive washer 190 is an annular shape with an opening in the center. In some embodiments, the non-conductive washer 190 does not include an opening, for example, the non-conductive washer 190 may be a disk shape without an opening.

Referring still to FIG. 2, the nozzle body 131 of the reduction control nozzle 130 comprises a barrier portion 132 positioned radially outward from the flow channel 135, and the barrier portion 132 comprising a lipped edge 133. When the reduction assembly 102 is assembled, the lipped edge 133 of the reduction control nozzle 130 engages with reduction crucible 110, forming a tortious interface between the reduction control nozzle 130 and the reduction crucible 110. The tortious interface minimizes material loss during a reduction process, when fluid is flowing from the reduction crucible 110, through the flow channel 135 of the reduction control nozzle 130, and into the first modular crucible 120A. In some embodiments, a mesh screen 192 is positioned in the flow channel 135, such that fluid flowing from the inlet opening 136 to the outlet opening 137 of the reduction control nozzle 130 traverses the mesh screen 192. The mesh screen 192 blocks solids, such as the rare earth oxide powder, from transferring from the reduction crucible 110 into the first modular crucible 120A, increasing the purity of rare earth metal collected in the first modular crucible 120A.

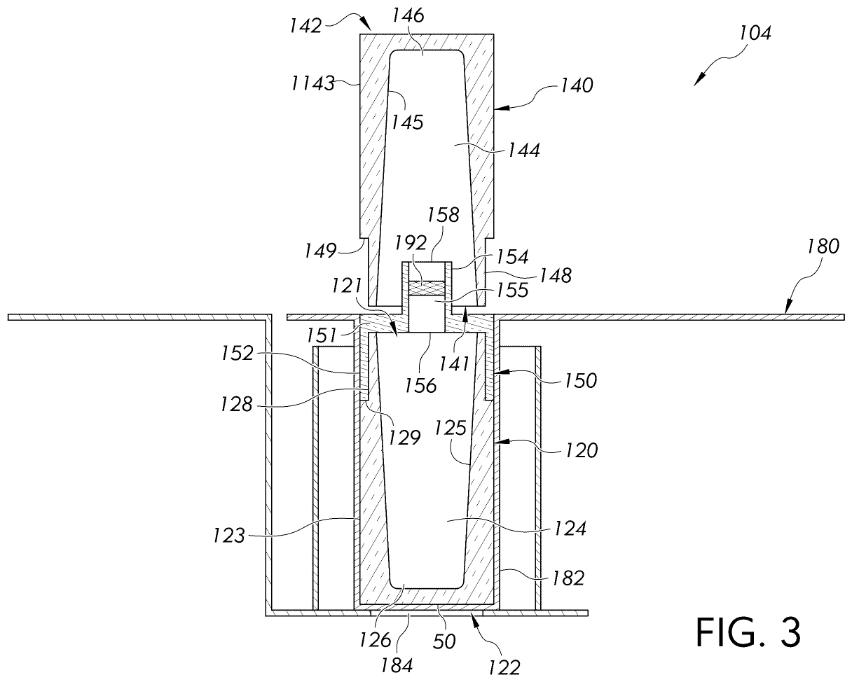

Referring now to FIG. 3, the cold sublimation assembly 104 is depicted as assembled. The cold sublimation assembly 104 may be assembled and disassembled. As shown in FIG. 3, when assembled, the sublimation control nozzle 150 is positioned between an open end 141 of the collection crucible 140 and an open end 121 of a modular crucible 120, fluidly coupling the collection crucible 140 to the modular crucible 120. The modular crucible 120 comprises a closed end 122 opposite the open end 121 and a crucible body 123. The crucible body 123 comprises an activity chamber 124, which is a chamber in which material may be located for undergoing a reaction, such as a separation process, or where material may be collected. The activity chamber 124 includes an activity surface 125. A portion of the activity surface 125 forms an activity floor 126, which is the portion of the activity surface 125 at the closed end 122 of the modular crucible 120. Similarly, the collection crucible 140 comprises an open end 141 opposite a closed end 142 and a crucible body 143. The crucible body 143 includes an activity chamber 144, which is a chamber in which material separated in the modular crucible 120 may be collected. The activity chamber 144 includes an activity surface 145. A portion of the activity surface 145 forms an activity floor 146, which is the portion of the activity surface 125 at the closed end 122 of the modular crucible 120. Indeed, in the embodiment depicted in FIG. 2, the collection crucible 140 is a modular crucible (like the modular crucible 120). However, it should be understood that the collection crucible 140 could be another crucible designed that includes the open end 141, the closed end 142, and a collection chamber such as the activity chamber 144.

Referring still to FIG. 3, the sublimation control nozzle 150 comprises a nozzle body 151 and a flow channel 155 extending through the nozzle body 131 from an inlet opening 156 to an outlet opening 158. The nozzle body 151 further comprises a protruding outlet 154 extending outwards from the remainder of the nozzle body 151, for example, in an upwards direction. The flow channel 155 is positioned such that the outlet opening 158 is located at the protruding outlet 154. When assembled, the protruding outlet 154 of the sublimation control nozzle 150 extends into the activity chamber 144 of the collection crucible 140. This positions the outlet opening 158 within the activity chamber 144 of the collection crucible 140, minimizing loss of fluid (e.g., vaporized rare earth metal, such as vaporized ytterbium) when transferring from the modular crucible 120 to the collection crucible 140 during the cold sublimation process, maximizing total mass recovery of the rare earth metal.

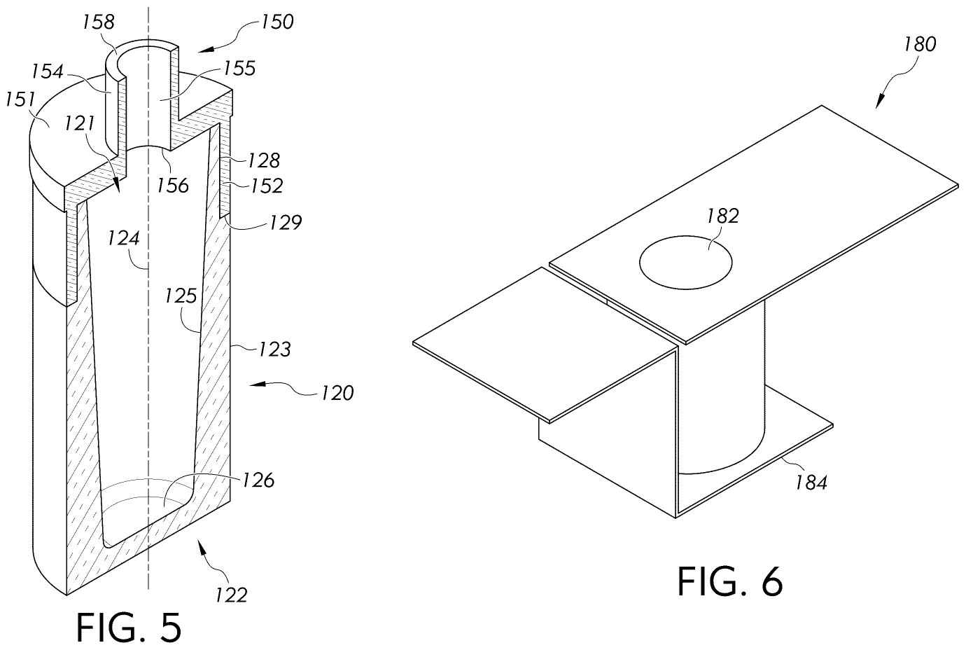

Referring still to FIG. 3, the nozzle body 151 of the sublimation control nozzle 150 comprises an edge extension 152 positioned radially outward from the flow channel 155. The edge extension 152 extends outward from the remainder of the nozzle body 151, for example, in a downward direction. In some embodiments, the protruding outlet 154 and the edge extension 152 each extend outwards from the nozzle body 151 in opposite directions. These opposite directions may both be parallel to the flow channel 155. As also depicted in FIG. 5, when the cold sublimation assembly 104 is assembled, the edge extension 152 of the sublimation control nozzle 150 engages with the modular crucible 120, for example, the interfacing edge 129 of the modular crucible 120, forming a tortious interface between the sublimation control nozzle 150 and the modular crucible 120. The tortious interface minimizes material loss during a separation process, when fluid is flowing from the modular crucible 120, through the flow channel 155 of the sublimation control nozzle 150, and into the collection crucible 140. In some embodiments, a mesh screen 192 is positioned in the flow channel 135, such that fluid flowing from the inlet opening 156 to the outlet opening 157 of the sublimation control nozzle 150 traverses the mesh screen 192. The mesh screen 192 blocks solids from transferring from the modular crucible 120, increasing the purity of rare earth metal collected in the modular crucible 120.

Referring now to FIGS. 3 and 6, the reduction assembly 102 further comprises a crucible heater 180. The crucible heater 180 includes a crucible receiving recess 182 terminating at a heater base 184. In some embodiments, the crucible heater 180 is a resistive heater. However, it should be understood that other types of heaters are contemplated, for example, inductive heaters. When the cold sublimation assembly 104 is assembled, the modular crucible 120 is positioned in the crucible receiving recess 182 of the crucible heater 180. In some embodiments, a non-conductive washer, like the non-conductive washer 190 of FIG. 2, is positioned between a base surface 50 of the modular crucible 120 and the heater base 184, for example, embodiments in which the crucible heater 180 is a resistive heater. While a non-conductive washer is not depicted in FIG. 3, it should be understood that The non-conductive washer separates the modular crucible 120 from contacting the heater base 184. In operation, when current is flowing through the crucible heater 180 and thereby generating heat to heat the modular crucible 120, the non-conductive washer blocks current flow from the heater base 184 of the crucible heater 180 to a base surface 50 of the modular crucible 120. In addition, the electrical break provided by the non-conductive washer facilitates the use of resistance temperature detectors (RTDs) and thermocouples to measure temperature because current flow through the modular crucible 120 would cause signal interference for the RTDs and thermocouples. In some embodiments, the non-conductive washer comprises a felt material. In some embodiments, the non-conductive washer is an annular shape with an opening in the center. In some embodiments, the non-conductive washer does not include an opening, for example, the non-conductive washer may be a disk shape without an opening.

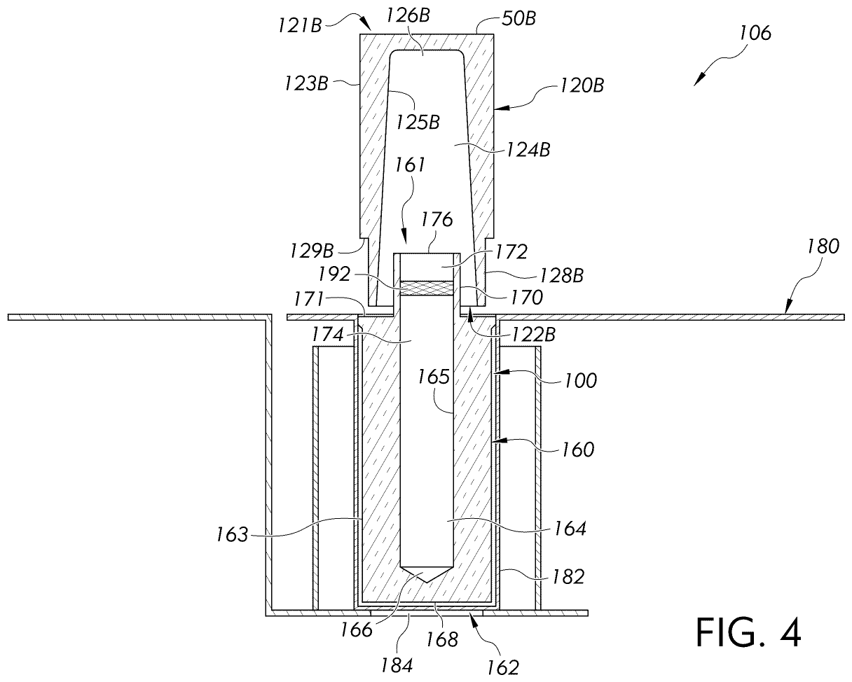

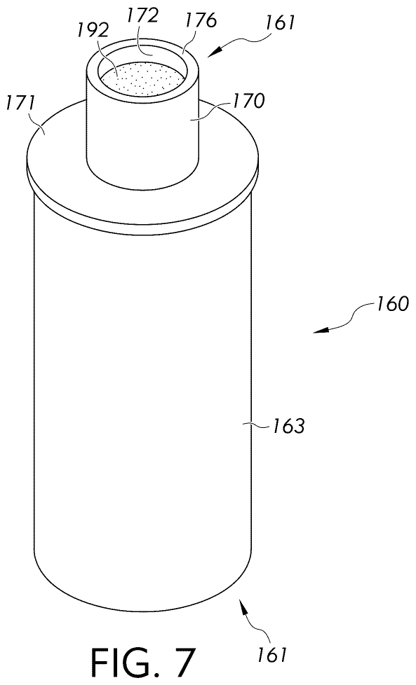

Referring now to FIG. 4, the hot sublimation assembly 106 is depicted as assembled. The hot sublimation assembly 106 may be assembled and disassembled. As shown in FIG. 4, when assembled, the hot sublimation crucible 160 is fluidly coupled to the second modular crucible 120B. As also depicted in FIG. 7, the hot sublimation crucible 160 comprises an open end 161 opposite a closed end 162 and a crucible body 163. The crucible body 163 comprises an activity chamber 164, which is a chamber in which material may be located for undergoing a reaction, such as a separation process. The activity chamber 164 includes an activity surface 165. A portion of the activity surface 165 forms an activity floor 166, which is the portion of the activity surface 165 at the closed end 162 of the hot sublimation crucible 160. The open end 161 of the hot sublimation crucible 160 includes a throat 170 comprising a throat channel 172 extending from a throat inlet 174 to a throat outlet 176. The throat 170 further comprises a throat barrier 171 partially enclosing the activity chamber 164. The throat channel 172 extends outward from the throat channel 172, for example, in an upwards direction.

The second modular crucible 120B comprises a closed end 122B opposite the open end 121B and a crucible body 123B. The crucible body 123B comprises an activity chamber 124B, which is a chamber in which material may be collected and, in some embodiments, reacted. The activity chamber 124B includes an activity surface 125B. A portion of the activity surface 125B forms an activity floor 126B, which is the portion of the activity surface 125B at the closed end 122B of the second modular crucible 120B. When assembled, the throat 170 of the hot sublimation crucible 160 extends into the activity chamber 124B of the second modular crucible 120B. In some embodiments, a mesh screen 192 is positioned in the throat channel 172 of the hot sublimation crucible 160, such that fluid flowing from the throat inlet 174 to the throat outlet 176 traverses the mesh screen 192. The mesh screen 192 blocks solids, such as the second rare earth element (e.g., Lu-177), from transferring from the modular crucible 120, maximizing the amount of the second rare earth metal, which may be a valuable material such as Lu-177, that is retained in the hot sublimation crucible 160.

In some embodiments, for example, embodiments in which the hot sublimation crucible 160 does not include the throat 170, the hot sublimation assembly 106 may further comprise a sublimation control nozzle 150, such as the sublimation control nozzle 150 depicted in FIG. 3. A sublimation control nozzle 150 disposed in hot sublimation assembly 106 may be referred to as a hot sublimation control nozzle 150. In such embodiments, when hot sublimation assembly 106 is assembled, the sublimation control nozzle 150 extends into the activity chamber 124B of the second modular crucible 120B. In such embodiments, a mesh screen 192 may be positioned in the flow channel 155 of the sublimation control nozzle 150. Indeed, embodiments of the hot sublimation assembly 106 are contemplated in which the hot sublimation crucible 160 is a modular crucible and such embodiments may include a sublimation control nozzle 150 as part of the hot sublimation assembly 106. This may further increase the modularity and redundancy in the phase change system 100.

Referring now to FIGS. 4 and 6, the hot sublimation assembly 106 further comprises a crucible heater 180. The crucible heater 180 includes a crucible receiving recess 182 terminating at a heater base 184. In some embodiments, the crucible heater 180 is a resistive heater. However, it should be understood that other types of heaters are contemplated, for example, inductive heaters. When the hot sublimation assembly 106 is assembled, the hot sublimation crucible 160 is positioned in the crucible receiving recess 182 of the crucible heater 180. In some embodiments, a non-conductive washer, like the non-conductive washer 190 of FIG. 2,) is positioned between a base surface 168 of the hot sublimation crucible 160 and the heater base 184, for example, embodiments in which the crucible heater 180 is a resistive heater. The non-conductive washer separates the hot sublimation crucible 160 from contacting the heater base 184. In operation, when current is flowing through the crucible heater 180 and thereby generating heat to heat the hot sublimation crucible 160, the non-conductive washer blocks current flow from the heater base 184 of the crucible heater 180 to the base surface 168 of the hot sublimation crucible 160. In addition, the electrical break provided by the non-conductive washer facilitates the use of resistance temperature detectors (RTDs) and thermocouples to measure temperature because current flow through the hot sublimation crucible 160 would cause signal interference for the RTDs and thermocouples. In some embodiments, the non-conductive washer comprises a felt material. In some embodiments, the non-conductive washer is an annular shape with an opening in the center. In some embodiments, the non-conductive washer does not include an opening, for example, the non-conductive washer may be a disk shape without an opening.

Referring now to FIGS. 1-7, in some embodiments, some or all of the reduction crucible 110, the modular crucible(s) 120 (e.g., the first modular crucible 120A, the second modular crucible 120B, and any additional modular crucibles 120, such as a third modular crucible), the collection crucible 140, and the hot sublimation crucible 160 comprise a material that is chemically non-reactive with ytterbium and are thermally conductive such that they may be actively heated or cooled. Example materials include steel, boron nitride, titanium nitride, quartz, glass, and ceramic, however, it should be understood that any material that is chemically non-reactive with the second element may be used. In some embodiments, some or all of the reduction crucible 110, the modular crucible(s) 120 (e.g., the first modular crucible 120A, the second modular crucible 120B, and any additional modular crucibles 120, such as a third modular crucible), the collection crucible 140, and the hot sublimation crucible 160 each comprise a refractory metal. Example refractory metals include tungsten, molybdenum, niobium, tantalum, and rhenium.

Referring still to FIGS. 1-7, a method of accumulating a target radioisotope using the phase change system 100 will now be described. The method includes a reduction step using the reduction assembly 102, a cold separation step using the cold sublimation assembly 104, and a hot separation step using the hot sublimation assembly 106. The reduction step includes heating a powder mixture comprising a rare earth oxide powder and a lanthanum powder in the reduction crucible 110 of the reduction assembly 102. In some embodiments, the rare earth oxide powder comprises an ytterbium oxide powder. Heating the powder mixture reduces the rare earth oxide powder into a rare earth metal composition that collects in the first modular crucible 120A. Without intending to be limited by theory, when the powder mixture is heated, the lanthanum strips oxygen off of the ytterbium oxide, turning the ytterbium oxide into a ytterbium metal, and the ytterbium metal is vaporized. The first modular crucible 120A may be positioned above the reduction crucible 110 such that a gaseous form of the rare earth metal composition flows from the reduction crucible 110 into the first modular crucible 120A, for example, onto the activity surface 125A. At the activity surface 125A, the rare earth metal composition may solidify and stick to the activity surface 125A by condensation. In some embodiments, the first modular crucible 120A may be actively cooled, for example, by a cooling fluid, to promote solidification of the rare earth metal composition onto the activity surface 125A. The rare earth metal composition comprise a rare earth metal, such as ytterbium, and may comprise some impurities, such as one or more of lanthanum, titanium, vanadium, zinc, molybdenum, tungsten, and tantalum.

In some embodiments, the powder mixture is a homogeneous mixture of rare earth oxide powder and lanthanum powder. Heating the powder mixture may be done by applying heat to the reduction crucible 110 using the crucible heater. The crucible heater used to heat the reduction crucible 110 may be the crucible heater discussed hereinabove, or the crucible heater used to heat the reduction crucible 110 may be an additional crucible heater. In some embodiments, the reduction of the rare earth oxide powder into a rare earth metal composition may be done using the methods described in U.S. patent application Ser. No. 18/210,366, which is incorporated herein by reference in its entirety.

As heat is applied to the powder mixture, ytterbium metal may sublimate from the powder mixture, separating from the ytterbium oxide, lanthanum, and lanthanum oxide, and collecting in the first modular crucible 120A. In contrast to the ytterbium oxide, lanthanum is retained in the reduction crucible 110 as heat is applied to the powder mixture. Thus, the ytterbium metal is separated from both the oxygen of the ytterbium oxide and from the lanthanum of the powder mixture. In some embodiments, the powder mixture is heated to a temperature in a range of from 200° C. to 1500° C. or 300° C. to 875° C., for example, a temperature of 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., or value in a range having any two of these values as endpoints. In one example operation, the powder mixture is first preheated to a first temperature in a range of from 300° C. to 500° C., such as 400° C. and then ramped up to a second temperature in a range of from 1000° C. to 1500° C., for example, 1100° C., 1200° C., 1300° C., or 1400° C., to drive the reduction reaction.

In some embodiments, when heating the powder mixture, the reduction assembly 102, including the reduction crucible 110 and the first modular crucible 120A may be positioned in an inert or reduced pressure environment. For example, the reduction assembly 102 may be positioned in a chamber that forms an inert or reduced pressure environment. The inert or reduced pressure environment may be an environment with a pressure in a range of from 2000 torr to 1×10⁻⁸, from 1520 torr to 1×10⁻⁸ torr, from 1000 torr to 1×10⁻⁸ torr, from 760 torr to 1×10⁻⁸ torr, from 700 torr to 1×10⁻⁸ torr, from 500 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ or less, 1×10⁻⁵ torr or less, 1×10⁻⁶ torr or less, from 2000 torr to 1×10⁻¹ torr, from 1520 torr to 1 torr, from 1000 torr to 1 torr, from 760 torr to 1 torr, from 760 torr to 250 torr, any range having any two of these values as endpoints, or any value in a range having any two of these values as endpoints.

After collecting the rare earth metal composition in the first modular crucible 120A, the modularity of the phase change system 100 can be utilized, for example, by positioning the first modular crucible on the crucible heater 180 (e.g., in a crucible receiving recess 182 of the crucible heater 180) while the rare earth metal composition remains disposed in the first modular crucible 120A. Next, the method moves to the cold sublimation step, which includes fluidly coupling the first modular crucible 120A to the collection crucible 140 using the sublimation control nozzle 150, such that the sublimation control nozzle 150 is positioned between the first modular crucible 120A and the collection crucible 140. This forms the cold sublimation assembly 104. In some embodiments, the collection crucible 140 is another modular crucible 120.

Next, the first modular crucible 120A is heated using the crucible heater 180, thereby heating the rare earth metal composition and phase separating the rare earth metal (e.g., an ytterbium metal) from the lanthanum metal leaving a higher weight percentage of the of the lanthanum metal in the first modular crucible 120A than was present in the rare earth metal composition and collecting a refined rare earth element composition in the collection crucible 140. The refined rare earth element composition comprises a higher weight percentage of the rare earth metal than the rare earth metal composition. The first modular crucible 120A may be positioned above the collection crucible 140 such that a gaseous form of the rare earth metal composition flows from the first modular crucible 120A into the collection crucible 140 120A, for example, onto the activity surface 145. At the activity surface 145, the refined rare earth element composition may solidify and stick to the activity surface 145 by condensation. In some embodiments, the collection crucible 140 may be actively cooled, for example, by a cooling fluid, to promote solidification of the refined rare earth metal composition onto the activity surface 145. In some embodiments, the rare earth metal composition is heated to a temperature in a range of from 200° C. to 900° C. or 300° C. to 875° C., for example, a temperature of 300° C., 350° C., 400° C., 450° C., 500° C., 550° C., 600° C., 625° C., 650° C., 675° C., 700° C., 750° C., 800° C., 850° C., 900° C., or value in a range having any two of these values as endpoints. In one example operation, the rare earth metal composition is first preheated to a first temperature in a range of from 250° C. to 400° C., such as 300° C. and then ramped up to a second temperature in a range of from 550° C. to 800° C., for example, 600° C., 650° C., 700° C., or 750° C., to drive the sublimation reaction.

In some embodiments, when heating the rare earth metal composition, the cold sublimation assembly 104, including the collection crucible 140 and the first modular crucible 120A may be positioned in an inert or reduced pressure environment. For example, cold sublimation assembly 104 may be positioned in chamber that forms an inert or reduced pressure environment. The inert or reduced pressure environment may be an environment with a pressure in a range of from 2000 torr to 1×10⁻⁸, from 1520 torr to 1×10⁻⁸ torr, from 1000 torr to 1×10⁻⁸ torr, from 760 torr to 1×10⁻⁸ torr, from 700 torr to 1×10⁻⁸ torr, from 500 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ or less, 1×10⁻⁵ torr or less, 1×10⁻⁶ torr or less, from 2000 torr to 1×10⁻¹ torr, from 1520 torr to 1 torr, from 1000 torr to 1 torr, from 760 torr to 1 torr, from 760 torr to 250 torr, any range having any two of these values as endpoints, or any value in a range having any two of these values as endpoints.

In some embodiments, the method may further comprise collecting the refined rare earth metal composition (e.g., the refined ytterbium composition) and, forming (e.g., pressing, pelletizing, or the like) the refined rare earth metal composition into a metal target. In some embodiments, the metal target comprises a metal pellet, which may be formed by pelletizing the refined first metal composition. The metal pellet may comprise a variety of shapes, such as a spherical shape, a cylindrical shape, an oblong shape, or the like. In some embodiments, the metal target comprises a metal foil. The metal target is substantially homogenous to facilitate uniform heat transfer and uniform irradiation. Next, the first metal target may be irradiated with neutrons to form a irradiated composition comprising a first rare earth metal and a second rare earth metal (e.g., ytterbium and lutetium, such as Yb-176 and Lu-177). The metal target comprising the refined rare earth metal composition may be irradiated by neutrons generated using a nuclear reactor, a particle accelerator, such as an ion beam source, or any other known or yet to be developed neutron source.

Referring still to FIGS. 1-7, the method moves to the hot sublimation step, in which the irradiated composition may be positioned in a sublimation crucible (e.g., the hot sublimation crucible 160, or another modular crucible 120) and the sublimation crucible may be fluidly coupled to a second modular crucible 120B, forming the hot sublimation assembly 106. In operation, the hot sublimation assembly 106 is used to separate the first rare earth metal and the second rare earth metal of the irradiated composition, via distillation or sublimation, isolating the target isotope (i.e., the second rare earth metal, which may comprise Lu-177) for accumulation. Indeed, the method further comprises heating the irradiated composition for a first heating period, thereby phase separating the first rare earth metal from the irradiated composition to leave a higher weight percentage of the second rare earth metal in the sublimation crucible than was present in the irradiated composition and collecting the first rare earth metal is the second modular crucible 120B.

The second modular crucible 120B may be positioned above the hot sublimation crucible 160 such that a gaseous form of the first rare earth metal flows from the hot sublimation crucible 160 into the second modular crucible 120B, for example, onto the activity surface 125B. At the activity surface 125B, the first rare earth metal may solidify and stick to the activity surface 125B by condensation. In some embodiments, the second modular crucible 120B may be actively cooled, for example, by a cooling fluid, to promote solidification of the rare earth metal composition onto the activity surface 145B. This leaves a high concentration of the second rare earth metal (e.g., a target radioisotope such as Lu-177) in the hot sublimation crucible 160.

For example, ytterbium may be sublimated from the irradiated composition in an environment at a temperature in a range of from 400° C. to 3000° C. to leave a target composition comprising a higher weight percentage of the target radioisotope (e.g., Lu-177) than was present in the irradiated composition. The environment may be a reduced pressure environment and/or an inert environment. In some embodiments, the temperature in the environment is less than 700° C. The lutetium composition may be subjected to chromatographic separation to further enrich the lutetium (e.g., the Lu-177) in the lutetium composition. Alternatively, the lutetium composition may be subjected to a non-aqueous separation technique to further enrich the lutetium in the lutetium composition, such as a non-aqueous, electrolytic reduction process using mercury.

The temperature for the target radioisotope yielding hot sublimation (e.g., the temperature in the environment) may be in a range of from 400° C. to 3000° C., for example, from 450° C. to 1500° C., from 450° C. to 1200° C., from 450° C. to 1000° C., from 400° C. to 1000° C., from 400° C. to 900° C., from 400° C. to 800° C., from 450° C. to 700° C., from 400° C. to less than 700° C., from 400° C. to 695° C., from 450° C. to 690° C., from 450° C. to 685° C., from 450° C. to 680° C., from 450° C. to 675° C., from 450° C. to 670° C., from 450° C. to 665° C., from 450° C. to 660° C., from 450° C. to 655° C., from 450° C. to 650° C., from 450° C. to 645° C., from 450° C. to 640° C., from 450° C. to 635° C., from 450° C. to 630° C., from 450° C. to 625° C., 470° C. to about 630° C., from 800° C. to 3000° C., from greater than 800° C. to 3000° C., from 1000° C. to 3000° C., from 1200° C. to 3000° C., from 1500° C. to 3000° C., or any range having any two of these values as endpoints. Indeed, the temperature for sublimation and/or distillation (e.g., the temperature in the environment) may be 400° C., 425° C., 450° C., 470° C., 475° C., 500° C., 525° C., 550° C., 575° C., 600° C., 625° C., 640° C., 650° C., 655° C., 660° C., 665° C., 670° C., 675° C., 680° C., 685° C., 690° C., 695° C., 698° C., 700° C., 725° C., 750° C., 775° C., 800° C., 850° C., 900° C., 950° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., 3000° C., any range having any two of these values as endpoints, or any value in a range having any two of these values as endpoints. Also, according to various embodiments, the pressure of the environment at any of the temperatures and temperature ranges described above may be in a range of from 2000 torr to 1×10⁻⁸, from 1520 torr to 1×10⁻⁸ torr, from 1000 torr to 1×10⁻⁸ torr, from 760 torr to 1×10⁻⁸ torr, from 700 torr to 1×10⁻⁸ torr, from 500 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ or less, 1×10⁻⁵ torr or less, 1×10⁻⁶ torr or less, from 2000 torr to 1×10⁻¹ torr, from 1520 torr to 1 torr, from 1000 torr to 1 torr, from 760 torr to 1 torr, from 760 torr to 250 torr, any range having any two of these values as endpoints, or any value in a range having any two of these values as endpoints.

Upon collection in the second modular crucible 120B, in embodiments in which the first rare earth metal is an ytterbium composition, the ytterbium composition may comprise both Yb-176 and Yb-175. This ytterbium composition is available for recycling (e.g., for another round of neutron irradiation) to produce further irradiated solid composition and to thereafter produce further lutetium in subsequent runs of the process. In some embodiments, the recycling of a collected ytterbium composition to produce further irradiated solid composition and to thereafter produce further lutetium in subsequent runs of the process, may be done using the methods described in U.S. patent application Ser. No. 18/218,960, which is incorporated herein by reference in its entirety. The method may comprise retaining the first rare earth metal for a waiting period to form a decayed first metal composition. The waiting period is longer than the first heating period. For example, the waiting period may be at least 4 days, for example, at least 5 days, at least 6 days, at least 1 week, at least 2 weeks, at least 3 weeks, at least 4 weeks, at least 5 weeks, at least 6 weeks, at least 7 weeks, at least 8 weeks, at least 9 weeks, at least 10 weeks, at least 11 weeks, at least 12 weeks, at least 13 weeks, at least 15 weeks, or longer, such as at least 52 weeks or at least 104 weeks. In embodiments in which the first rare earth metal composition comprises a ytterbium composition, during the waiting period, the Yb-175 present in the ytterbium composition decays partially into Lu-175, forming a decayed ytterbium composition. The half-life of Yb-175 is about 4 days. Indeed, in an 8-week waiting period, 99.991% of the Yb-175 present in the ytterbium composition decays into Lu-175. In some embodiments, the ytterbium composition may be retained for a waiting period after which 50% or more of the Yb-175 present in the ytterbium composition decays into Lu-175, for example, 75% or more, 90% or more, 95% or more, 95% or more, 99.3% or more, 99.5% or more, 99.7% or more, 99.9% or more, 99.95% or more, 99.97% or more, 99.99% or more, 99.995% or more, 99.999% or more, or 99.9999% or more.

Lu-175 is stable and non-radioactive. Lu-175 is also a contaminant in Lu-177 based radiopharmaceuticals. Lu-175 degrades the specific activity of Lu-177 based radiopharmaceuticals because it is stable and non-radioactive. Lu-175 can also lead to the formation of Lu-176m during the next irradiation of the process described herein. Minimizing Lu-175 and Lu-176m may be required to meet purity requirements for some radiopharmaceutical products. Table 1, below, includes additional details for Lu-175 and Lu-176. As shown in Table 1, the production of Lu-177m2 occurs from Lu-176 and has a half-life of approximately 160 days, which poses a hazard to patients as it can remain in the body and potentially result in off-target cell damage.

TABLE 1

| | | | | | | | Main γ rays in |
|---|---|---|---|---|---|---|---|
| | Atomic | | σ₀, | Activation | | Decay | KeV (absolute |
| Element | Mass | Abundance | barn | Product | T_{1/2} | Product(s) | intensity, %) |
| Lu | 175 | 97.41% | 16.7 ± | ^{176m}Lu | 3.664 | ¹⁷⁶Hf | 88.36 (8.9) |
| | | | 0.4 | | hours | | |
| | | | 6.6 ± | ¹⁷⁶Lu | 4 × | ¹⁷⁶Hf | 88.34 (14.5), |
| | | | 1.3 | | 10¹⁰ | | 201.83 (78.0), |
| | | | | | years | | 306.78 (93.6) |
| | 176 | 2.59% | 317 ± | ^{177m1}Lu | 6 | N/A | N/A |
| | | | 58 | | mins | | |
| | | | 2.8 ± | ^{177m2}Lu | 160.44 | ¹⁷⁷Hf | 112.95 (21.9), |
| | | | 0.7 | | days | (78.6%) | 128.5 (15.6), |
| | | | | | | ¹⁷⁷Lu | 153.28 (17.0), |
| | | | | | | (21.4%) | 204.11 (13.9), |
| | | | | | | | 208.37 (57.4), |
| | | | | | | | 228.48 (37.2), |
| | | | | | | | 281.79 (14.2), |
| | | | | | | | 327.68 (18.1), |
| | | | | | | | 378.5 (29.9), |
| | | | | | | | 418.54 (21.3) |
| | | | 2020 ± | ¹⁷⁷Lu | 6.647 | ¹⁷⁷Hf | 112.95 (6.17), |
| | | | 70 | | days | | 136.72 (0.05), |
| | | | | | | | 208.37 (10.36), |
| | | | | | | | 249.67 (0.20), |
| | | | | | | | 321.32 (0.31) |

Retaining the ytterbium composition allows most of the Yb-175 to decay to Lu-175 and form the decayed ytterbium composition. This allows the Lu-175 to be removed from the decayed ytterbium composition with an additional separation step, for example, using the cold sublimation assembly 104. During the waiting period, the first rare earth metal and the subsequently formed, decayed first metal composition may be retained in the second modular crucible 120B and the modularity of the phase change system 100 can again be utilized when performing this additional separation step. In particular, subsequent to the waiting period, the method next comprises positioning the second modular crucible 120B on the crucible heater 180 (e.g., onto the crucible heater 180 of the cold sublimation assembly 104) while the decayed first metal composition remains disposed in the second modular crucible 120B. For example, the second modular crucible 120B may be positioned in the crucible receiving recess 182 of the crucible heater 180.

Next, the second modular crucible 120B is fluidly coupled to the collection crucible 140 using the sublimation control nozzle 150 that the sublimation control nozzle 150 is positioned between the second modular crucible 120B and the collection crucible 140 and heating the second modular crucible 120B using the crucible heater 180, thereby sublimating or distilling a refined first metal composition from the decayed first metal composition for a second heating period, leaving a waste composition in the second modular crucible 120B and collecting the refined first metal composition in a collection crucible 140. The sublimation control nozzle used to fluidly couple the second modular crucible 120B to the collection crucible 140 may be the sublimation control nozzle 150 described hereinabove, or the sublimation control nozzle used to fluidly couple the second modular crucible 120B to the collection crucible 140 may be an additional sublimation control nozzle. In some embodiments, the refined first metal composition comprises a refined ytterbium composition. The refined ytterbium composition may comprise 0.1 weight percent (wt. %) Lu-175 or less, for example, 0.05 wt. % or less, 0.02 wt. % or less, 0.01 wt. % or less, 0.005 wt. % or less, 0.004 wt. % or less, 0.003 wt. % or less, 0.002 wt. % or less, 0.001 wt. % or less, 0.0005 wt. % or less, 0.0001 wt. % or less, or a value in a range having any two of these values as endpoints.

By separating the refined ytterbium composition and the waste composition, the refined ytterbium composition comprises a higher weight percentage of ytterbium than was present in the decayed ytterbium composition. In addition to Lu-175, the waste composition may further comprise one or more ytterbium oxides, one or more ytterbium silicates, and elements with a low vapor pressure, such as lanthanum, iron, aluminum, nickel, copper, cerium, tin, erbium, cobalt, silicon, chromium, tantalum, titanium, molybdenum, manganese, and mixtures and alloys thereof. Each of these is undesirable in a Lu-177 based radiopharmaceutical. Moreover, these impurities may also be undesirable when the refined ytterbium composition is irradiated. Without intending to be limited by theory, the impurities could cause an excessive radiative does to facility operators if the impurities were irradiated and activated in a neutron source facility, such as a reactor. In other words, removing the waste composition from the decayed ytterbium composition (i.e., forming the refined ytterbium) acts as a purification step to remove the impurities from the decayed ytterbium composition, impurities that form the waste composition.

In some embodiments, the method may further comprise collecting the refined first metal composition (e.g., the refined ytterbium composition) and, forming (e.g., pressing, pelletizing, or the like) the refined first metal composition into a first metal target. In some embodiments, the first metal target comprises a first metal pellet, which may be formed by pelletizing the refined first metal composition. The first metal pellet may comprise a variety of shapes, such as a spherical shape, a cylindrical shape, an oblong shape, or the like. In some embodiments, the first metal target comprises a first metal foil. The first metal target is substantially homogenous to facilitate uniform heat transfer and uniform irradiation. Next, the first metal target may be irradiated with neutrons to form a recycled irradiated composition comprising the first metal and a second metal (e.g., ytterbium and lutetium, such as Yb-176 and Lu-177). The first metal target may be irradiated by neutrons generated using a nuclear reactor, a particle accelerator, such as an ion beam source, or any other known or yet to be developed neutron source.

Next, the recycled irradiated composition may be positioned in a sublimation crucible (e.g., the hot sublimation crucible 160, or another modular crucible 120) and the sublimation crucible may be fluidly coupled to the second modular crucible 120B or another modular crucible 120, forming the hot sublimation assembly 106 and the hot sublimation assembly 106 is used to separate the first rare earth metal and the second rare earth metal of the irradiated composition, via distillation or sublimation, isolating additional target isotope (i.e., the second rare earth metal) for accumulation, using the process described above for separating the irradiated composition. The second rare earth metal (e.g., lutetium) and the separated first rare earth element (e.g., ytterbium) may each be collected. The process may be repeated on the collected first rare earth element, which continues to benefit from the modularity of the phase change system 100.

According to a first aspect of the present disclosure, a phase change system includes a reduction assembly, a cold sublimation assembly, and a hot sublimation assembly, wherein: the reduction assembly comprises a reduction crucible, a first modular crucible, and a reduction control nozzle and, when assembled, the reduction control nozzle is positioned between an open end of the reduction crucible and an open end of the first modular crucible and a protruding outlet of the reduction control nozzle extends into an activity chamber of the first modular crucible; the cold sublimation assembly comprises a collection crucible and a cold sublimation control nozzle and, when assembled, the cold sublimation control nozzle extends into an activity chamber of the collection crucible; and the hot sublimation assembly comprises a hot sublimation crucible and a second modular crucible and, when assembled, the hot sublimation crucible is fluidly coupled to the second modular crucible.

A second aspect includes the phase change system of the first aspect, wherein the reduction assembly further comprises a crucible heater having a crucible receiving recess terminating at a heater base.

A third aspect include the phase change system of the second aspect, wherein the crucible heater of the reduction assembly is a resistive heater.

A fourth aspect includes the phase change system of the second or third aspect, wherein the reduction crucible comprises a base surface at a closed end of the reduction crucible and when the reduction assembly is assembled, the reduction crucible is positioned in the crucible receiving recess of the crucible heater and a non-conductive washer is positioned between the base surface of the reduction crucible and the heater base, thereby blocking current flow from the heater base to the base surface.

A fifth aspect includes the phase change system of the fourth aspect, wherein the non-conductive washer comprises a felt material.

A sixth aspect includes the phase change system of the fourth or fifth aspect, wherein the non-conductive washer separates the reduction crucible from contacting the heater base.

A seventh aspect includes the phase change system of any of the previous aspects, wherein the reduction control nozzle comprises a flow channel extending from an inlet opening to an outlet opening, wherein the outlet opening is located at the protruding outlet, and a mesh screen is positioned in the flow channel, such that fluid flowing from the inlet opening to the outlet opening traverses the mesh screen.

An eighth aspect includes the phase change system of any of the previous aspects, wherein the reduction crucible and the first modular crucible each comprise a refractory metal.

A ninth aspect includes the phase change system of any of the previous aspects, wherein the reduction crucible and the first modular crucible each comprise a material that is chemically non-reactive with ytterbium.

A tenth aspect includes the phase change system of any of the previous aspects, wherein the reduction control nozzle comprises a nozzle body and a flow channel extending through the nozzle body from an inlet opening to an outlet opening, the nozzle body comprising a barrier portion positioned radially outward from the flow channel, and the barrier portion comprising a lipped edge.

An eleventh aspect includes the phase change system of the tenth aspect, wherein when the reduction assembly is assembled, the lipped edge of the reduction control nozzle engages with reduction crucible, forming a tortious interface between the reduction control nozzle and the reduction crucible.

A twelfth aspect includes the phase change system of any of the previous aspects, wherein the hot sublimation assembly further comprises a crucible heater having a crucible receiving recess terminating at a heater base.

A thirteenth aspect includes the phase change system of the twelfth aspect, wherein the crucible heater of the hot sublimation assembly is a resistive heater.

A fourteenth aspect includes the phase change system of the twelfth or thirteenth aspect, wherein the hot sublimation crucible comprises a base surface at a closed end of the hot sublimation and when the hot sublimation assembly is assembled, the hot sublimation is positioned in the crucible receiving recess of the crucible heater and a non-conductive washer is positioned between the base surface of the hot sublimation crucible and the heater base, thereby blocking current flow from the heater base to the base surface.

A fifteenth aspect includes the phase change system of the fourteenth aspect, wherein the non-conductive washer comprises a felt material.

A sixteenth aspect includes the phase change system of the fourteenth or fifteenth aspect, wherein the non-conductive washer separates the reduction crucible from contacting the heater base.

A seventeenth aspect includes the phase change system of any of the previous aspects, wherein the hot sublimation crucible comprises an open end opposite a closed end, the open end including a throat comprising a throat channel extending from a throat inlet to a throat outlet and, when the hot sublimation assembly is assembled, the throat outlet extends into an activity chamber of the second modular crucible.

An eighteenth aspect includes the phase change system of the seventeenth aspect, wherein a mesh screen is positioned in the throat channel of the hot sublimation crucible, such that fluid flowing from the throat inlet to the throat outlet traverses the mesh screen.

A nineteenth aspect includes the phase change system of any of the previous aspects, wherein the hot sublimation assembly comprises a hot sublimation control nozzle and, when assembled, the hot sublimation control nozzle extends into an activity chamber of the second modular crucible.

A twentieth aspect includes the phase change system of the nineteenth aspect, wherein: the hot sublimation control nozzle comprises a flow channel comprising an inlet opening and an outlet opening; and a mesh screen is positioned in the flow channel, such that fluid flowing from the inlet opening to the outlet opening traverses the mesh screen.

A twenty-first aspect includes the phase change system of any of the previous aspects, wherein the hot sublimation crucible and the second modular crucible each comprise a refractory metal.

A twenty-second aspect includes the phase change system of any of the previous aspects, wherein the hot sublimation crucible and the second modular crucible each comprise a material that is chemically non-reactive with ytterbium.

A twenty-third aspect includes the phase change system of any of the previous aspects, wherein when the cold sublimation assembly is assembled, the cold sublimation control nozzle is positioned between an open end of the collection crucible and the open end of the first modular crucible or the second modular crucible.

A twenty-fourth aspect includes the phase change system of any of the previous aspects, wherein the first modular crucible and the second modular crucible each comprise: a crucible body; a closed end opposite the open end; an activity chamber; and an end shoulder comprising an interfacing edge terminating at the open end.

A twenty-fifth aspect includes the phase change system of the twenty-fourth aspect, wherein the cold sublimation control nozzle comprises a nozzle body and a flow channel extending through the nozzle body from an inlet opening to an outlet opening, the nozzle body comprising an edge extension positioned radially outward the flow channel.

A twenty-sixth aspect includes the phase change system of the twenty-fifth aspect, wherein when the cold sublimation assembly is assembled, the edge extension of the cold sublimation control nozzle engages the interfacing edge of the first modular crucible or the second modular crucible, forming a tortious interface between the cold sublimation control nozzle and the first modular crucible or the second modular crucible.

A twenty-seventh aspect includes the phase change system of the twenty-fifth or twenty-sixth aspect, wherein a mesh screen is positioned in the flow channel, such that fluid flowing from the inlet opening to the outlet opening traverses the mesh screen.

A twenty-eighth aspect includes the phase change system of any of the twenty-third through twenty-seventh aspects, wherein the cold sublimation assembly further comprises a crucible heater having a crucible receiving recess terminating at a heater base.

A twenty-ninth aspect includes the phase change system of the twenty-eighth aspect, wherein the crucible heater of the cold sublimation assembly is a resistive heater.

A thirtieth aspect includes the phase change system of the twenty-eighth or twenty-ninth aspect, wherein the first modular crucible and the second modular crucible each comprise a base surface at a closed end and when the cold sublimation assembly is assembled, the first modular crucible or the second modular crucible is positioned in the crucible receiving recess of the crucible heater and a non-conductive washer is positioned between the base surface of the first modular crucible or the second modular crucible and the heater base, thereby blocking current flow from the heater base to the base surface of the first modular crucible or the second modular crucible.

A thirty-first aspect includes the phase change system of the thirtieth aspect, wherein the non-conductive washer comprises a felt material.

A thirty-second aspect includes the phase change system of the thirtieth or thirty-first aspect, wherein the non-conductive washer separates the first modular crucible or the second modular crucible from contacting the heater base.

According to a thirty-third aspect of the present disclosure, a method includes heating a powder mixture comprising a rare earth oxide powder and a lanthanum powder in a reduction crucible, wherein heating the powder mixture reduces the rare earth oxide powder into a rare earth metal composition that collects in a first modular crucible, wherein the rare earth metal composition comprises a rare earth metal and a lanthanum metal; positioning the first modular crucible on a crucible heater while the rare earth metal composition is disposed in the first modular crucible; fluidly coupling the first modular crucible to a collection crucible using a sublimation control nozzle, such that the sublimation control nozzle is positioned between the first modular crucible and the collection crucible, the sublimation control nozzle comprising a flow channel; and heating the first modular crucible using the crucible heater, thereby heating the rare earth metal composition and phase separating the rare earth metal from the lanthanum metal leaving a higher weight percentage of the of the lanthanum metal in the first modular crucible than was present in the rare earth metal composition and collecting a refined rare earth element composition in a collection crucible, wherein the refined rare earth element composition comprises a higher weight percentage of the rare earth metal than the rare earth metal composition.

A thirty-fourth aspect includes the method of the thirty-third aspect, wherein the rare earth metal is a first rare earth metal and the method further comprises irradiating the refined rare earth element composition thereby forming an irradiated composition comprising the first rare earth metal and a second rare earth metal.

A thirty-fifth aspect includes the method of the thirty-fourth aspect, wherein the first rare earth metal comprises lutetium and the second rare earth metal comprises ytterbium.

A thirty-sixth aspect includes the method of the thirty-fourth or thirty-fifth aspect, further comprising positioning the irradiated composition in a sublimation crucible and fluidly coupling the sublimation crucible to a second modular crucible.

A thirty-seventh aspect includes the method of the thirty-sixth aspect, further comprising heating the irradiated composition for a first heating period, thereby phase separating the first rare earth metal from the irradiated composition to leave a higher weight percentage of the second rare earth metal than was present in the irradiated composition; and collecting the first rare earth metal in the second modular crucible.

A thirty-eighth aspect includes the method of the thirty-seventh aspect, further comprising retaining the first rare earth metal for a waiting period to form a decayed first metal composition, wherein the waiting period is longer than the first heating period; and subsequent to the waiting period, positioning the second modular crucible on the crucible heater while the decayed first metal composition is disposed in the second modular crucible; fluidly coupling the second modular crucible to the collection crucible using a sublimation control nozzle, such that the sublimation control nozzle is positioned between the second modular crucible and the collection crucible; heating the second modular crucible using the crucible heater, thereby sublimating or distilling a refined first metal composition from the decayed first metal composition for a second heating period, leaving a waste composition in the second modular crucible; and collecting the refined first metal composition in a collection crucible.

A thirty-ninth aspect includes the method of the thirty-eighth aspect, further comprising irradiating the refined first metal composition thereby forming a recycled irradiated composition comprising the first rare earth metal and the second rare earth metal.

A fortieth aspect includes the method of the thirty-ninth aspect, wherein the first rare earth metal comprises lutetium and the second rare earth metal comprises ytterbium.

A forty-first aspect includes the method of the thirty-ninth or fortieth aspects, further comprising heating the recycled irradiated composition for a first heating period, thereby phase separating the first rare earth metal from the recycled irradiated composition to leave a higher weight percentage of the second rare earth metal than was present in the recycled irradiated composition.

A forty-second aspect includes the method of any of the thirty-third through forty-first aspects, wherein, when heating the powder mixture, the reduction crucible is positioned in a reduced pressure environment.

A forty-third aspect includes the method of any of the thirty-third through forty-second aspects, wherein heating the powder mixture comprises applying heat to the reduction crucible using a crucible heater.

A forty-fourth aspect includes the method of any of the thirty-third through forty-third aspects wherein the rare earth oxide powder comprises an ytterbium oxide powder and the rare earth metal comprises an ytterbium metal.

A forty-fifth aspect includes the method of any of the thirty-third through forty-fourth aspects, wherein the powder mixture is a homogeneous mixture of rare earth oxide powder and lanthanum powder.

A forty-sixth aspect includes the method of any of the thirty-third through forty-fifth aspects, further comprising cooling the first modular crucible while heating powder mixture to promote collection of the rare earth metal in the first modular crucible.

According to a forty-seventh aspect of the present disclosure, a phase change system includes a reduction assembly, a cold sublimation assembly, and a hot sublimation assembly, wherein: the reduction assembly comprises a reduction crucible, a first modular crucible, and a reduction control nozzle and, when assembled, the reduction control nozzle is positioned between an open end of the reduction crucible and an open end of the first modular crucible; the hot sublimation assembly comprises a hot sublimation crucible and a second modular crucible comprising an open end and, when assembled, the hot sublimation crucible is fluidly coupled to the second modular crucible; and the cold sublimation assembly comprises a collection crucible and a sublimation control nozzle and, when assembled, the sublimation control nozzle is positioned between an open end of the collection crucible and the open end of the first modular crucible or the open end of the second modular crucible.

A forty-eighth aspect includes the phase change system of the forty-seventh aspect, wherein the reduction assembly further comprises a crucible heater having a crucible receiving recess terminating at a heater base.

A forty-ninth aspect includes the phase change system of the forty-eighth aspect, wherein the crucible heater of the reduction assembly is a resistive heater.

A fiftieth aspect includes the phase change system of the forty-eighth or forty-ninth aspect, wherein the reduction crucible comprises a base surface at a closed end of the reduction crucible and when the reduction assembly is assembled, the reduction crucible is positioned in the crucible receiving recess of the crucible heater and a non-conductive washer is positioned between the base surface of the reduction crucible and the heater base, thereby blocking current flow from the heater base to the base surface.

A fifty-first aspect includes the phase change system of the fiftieth aspect, wherein the non-conductive washer comprises a felt material.

A fifty-second aspect includes the phase change system of the fiftieth or fifty-first aspect, wherein the non-conductive washer separates the reduction crucible from contacting the heater base.

A fifty-third aspect includes the phase change system of any of the forty-seventh through fifty-second aspects, wherein the reduction control nozzle comprises a flow channel extending from an inlet opening to an outlet opening, wherein the outlet opening is located at the protruding outlet, and a mesh screen is positioned in the flow channel, such that fluid flowing from the inlet opening to the outlet opening traverses the mesh screen.

A fifty-fourth aspect includes the phase change system of any of the forty-seventh through fifty-third aspects, wherein the reduction control nozzle comprises a nozzle body and a flow channel extending through the nozzle body from an inlet opening to an outlet opening, the nozzle body comprising a barrier portion positioned radially outward from the flow channel, and the barrier portion comprising a lipped edge.

A fifty-fifth aspect includes the phase change system of the fifty-fourth aspect, wherein when the reduction assembly is assembled, the lipped edge of the reduction control nozzle engages with reduction crucible, forming a tortious interface between the reduction control nozzle and the reduction crucible.

A fifty-sixth aspect includes the phase change system of any of the forty-seventh through fifty-fifth aspects, wherein the hot sublimation assembly further comprises a crucible heater having a crucible receiving recess terminating at a heater base.

A fifty-seventh aspect includes the phase change system of the fifty-sixth aspect, wherein the crucible heater of the hot sublimation assembly is a resistive heater.

A fifty-eighth aspect includes the phase change system of the fifty-sixth or fifty-seventh aspect, wherein the hot sublimation crucible comprises a base surface at a closed end of the hot sublimation and when the hot sublimation assembly is assembled, the hot sublimation is positioned in the crucible receiving recess of the crucible heater and a non-conductive washer is positioned between the base surface of the hot sublimation crucible and the heater base, thereby blocking current flow from the heater base to the base surface.

A fifty-ninth aspect includes the phase change system of the fifty-eighth aspect, wherein the non-conductive washer comprises a felt material.

A sixtieth aspect includes the phase change system of the fifty-eighth or fifty-ninth aspect, wherein the non-conductive washer separates the reduction crucible from contacting the heater base.

A sixty-first aspect includes the phase change system of any of the forty-seventh through sixtieth aspects, wherein the hot sublimation crucible comprises an open end opposite a closed end, the open end including a throat comprising a throat channel extending from a throat inlet to a throat outlet and, when the hot sublimation assembly is assembled, the throat outlet extends into an activity chamber of the second modular crucible.

A sixty-second aspect includes the phase change system of the sixty-first aspect, wherein a mesh screen is positioned in the throat channel of the hot sublimation crucible, such that fluid flowing from the throat inlet to the throat outlet traverses the mesh screen.

A sixty-third aspect includes the phase change system of any of the forty-seventh through sixty-second aspects, wherein the hot sublimation assembly comprises a hot sublimation control nozzle and, when assembled, the hot sublimation control nozzle extends into an activity chamber of the second modular crucible.

A sixty-fourth aspect includes the phase change system of the sixty-third aspect, wherein the hot sublimation control nozzle comprises a flow channel comprising an inlet opening and an outlet opening; and a mesh screen is positioned in the flow channel, such that fluid flowing from the inlet opening to the outlet opening traverses the mesh screen.

A sixty-fifth aspect includes the phase change system of any of the forty-seventh through sixty-fourth aspects, wherein the first modular crucible and the second modular crucible each comprise: a crucible body; a closed end opposite the open end; an activity chamber; and an end shoulder comprising an interfacing edge terminating at the open end.

A sixty-sixth aspect includes the phase change system of any of the forty-seventh through sixty-fifth aspects, wherein the cold sublimation control nozzle comprises a nozzle body and a flow channel extending through the nozzle body from an inlet opening to an outlet opening, the nozzle body comprising an edge extension positioned radially outward the flow channel.

A sixty-seventh aspect includes the phase change system of the sixty-sixth aspect, wherein when the cold sublimation assembly is assembled, the edge extension of the cold sublimation control nozzle engages the interfacing edge of the first modular crucible or the second modular crucible, forming a tortious interface between the cold sublimation control nozzle and the first modular crucible or the second modular crucible.

A sixty-eighth aspect includes the phase change system of the sixty-sixth or sixty-seventh aspect, wherein a mesh screen is positioned in the flow channel, such that fluid flowing from the inlet opening to the outlet opening traverses the mesh screen.

A sixty-ninth aspect includes the phase change system of any of the forty-seventh through sixty-eighth aspects, wherein the cold sublimation assembly further comprises a crucible heater having a crucible receiving recess terminating at a heater base.

A seventieth aspect includes the phase change system of the sixty-ninth aspect, wherein the crucible heater of the cold sublimation assembly is a resistive heater.

A seventy-first aspect includes the phase change system of the sixty-ninth or seventieth aspect, wherein the first modular crucible and the second modular crucible each comprise a base surface at a closed end and when the cold sublimation assembly is assembled, the first modular crucible or the second modular crucible is positioned in the crucible receiving recess of the crucible heater and a non-conductive washer is positioned between the base surface of the first modular crucible or the second modular crucible and the heater base, thereby blocking current flow from the heater base to the base surface of the first modular crucible or the second modular crucible.

A seventy-second aspect includes the phase change system of the seventy-first aspect, wherein the non-conductive washer comprises a felt material.

A seventy-third aspect includes the phase change system of the seventy-first or seventy-second aspect, wherein the non-conductive washer separates the first modular crucible or the second modular crucible from contacting the heater base.

According to a seventy-fourth aspect of the present disclosure, a phase change system includes a reduction assembly, a cold sublimation assembly, and a hot sublimation assembly, wherein: the reduction assembly comprises a reduction crucible, a first modular crucible, and a reduction control nozzle; the reduction control nozzle comprises a flow channel configured to be positioned between an open end of the reduction crucible and an open end of the first modular crucible such that the flow channel fluidly couples the reduction crucible and the first modular crucible; the hot sublimation assembly comprises a hot sublimation crucible and a second modular crucible; the cold sublimation assembly comprises a collection crucible, a sublimation control nozzle, and one of the first modular crucible, the second modular crucible, or a third modular crucible; and the sublimation control nozzle comprises a flow channel is configured to be positioned between an open end of the one of the first modular crucible, the second modular crucible, or the third modular crucible, and an open end of the collection such that the flow channel fluidly couples the collection crucible and the one of the first modular crucible, the second modular crucible, or the third modular crucible.

A seventy-fifth aspect includes the phase change system of the seventy-fourth aspect, wherein the one of the first modular crucible, the second modular crucible, or the third modular crucible is the first modular crucible.

A seventy-sixth aspect includes the phase change system of the seventy-fourth aspect, wherein the one of the first modular crucible, the second modular crucible, or the third modular crucible is the second modular crucible.

A seventy-seventh aspect includes the phase change system of the seventy-fourth aspect, wherein the one of the first modular crucible, the second modular crucible, or the third modular crucible is the third modular crucible.

According to a seventy-eighth aspect of the present disclosure, an assembly includes a first modular crucible and a second modular crucible, each comprising: an open end opposite a closed end; a crucible body; an activity chamber; and an end shoulder comprising an interfacing edge terminating at the open end; and a sublimation control nozzle comprising a nozzle body and a flow channel extending through the nozzle body from an inlet opening to an outlet opening, the nozzle body comprising an edge extension positioned radially outward the flow channel wherein: the sublimation control nozzle is positioned between the open end of the first modular crucible and the second modular crucible, fluidly coupling the first modular crucible and the second modular crucible; and the edge extension of the sublimation control nozzle engages the interfacing edge of the first modular crucible, forming a tortious interface between the sublimation control nozzle and the first modular crucible.

A seventy-ninth aspect includes the assembly of the seventy-eighth aspect, wherein the sublimation control nozzle further comprises a protruding outlet that extends into an activity chamber of the second modular crucible.

An eightieth aspect includes the assembly of the seventy-eighth or seventy-ninth aspect, wherein a mesh screen is positioned in the flow channel, such that fluid flowing from the inlet opening to the outlet opening traverses the mesh screen.

An eighty-first aspect includes the assembly of any of the seventy-eighth through eightieth aspects, wherein the assembly further comprises a crucible heater having a crucible receiving recess terminating at a heater base.

An eighty-second aspect includes the assembly of the eighty-first aspect, wherein the crucible heater of the assembly is a resistive heater.

An eighty-third aspect includes the assembly of the eighty-first or eighty-second aspect, wherein the first modular crucible is positioned in the crucible receiving recess of the crucible heater.

An eighty-fourth aspect includes the assembly of the eighty-third aspect, wherein a non-conductive washer is positioned between a base surface of the first modular crucible and the heater base.

An eighty-fifth aspect includes the assembly of the eighty-fourth aspect, wherein the non-conductive washer blocks current flow from the heater base to the base surface of the first modular crucible.

An eighty-sixth aspect includes the assembly of the eighty-fourth or eighty-fifth aspect, wherein the non-conductive washer comprises a felt material.

An eighty-seventh aspect includes the assembly of any of the eighty-fourth through eighty-sixth aspects, wherein the non-conductive washer separates the first modular crucible from contacting the heater base.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, optical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter

What is claimed is:

1. A phase change system comprising a reduction assembly, a cold sublimation assembly, and a hot sublimation assembly, wherein:
the reduction assembly comprises a reduction crucible, a first modular crucible, and a reduction control nozzle and, when assembled, the reduction control nozzle is positioned between an open end of the reduction crucible and an open end of the first modular crucible and a protruding outlet of the reduction control nozzle extends into an activity chamber of the first modular crucible;
the cold sublimation assembly comprises a collection crucible and a cold sublimation control nozzle and, when assembled, the cold sublimation control nozzle extends into an activity chamber of the collection crucible; and
the hot sublimation assembly comprises a hot sublimation crucible and a second modular crucible and, when assembled, the hot sublimation crucible is fluidly coupled to the second modular crucible.

2. The phase change system of claim 1, wherein the reduction assembly further comprises a crucible heater having a crucible receiving recess terminating at a heater base.

3. The phase change system of claim 2, wherein the crucible heater of the reduction assembly is a resistive heater.

4. The phase change system of claim 2, wherein the reduction crucible comprises a base surface at a closed end of the reduction crucible and when the reduction assembly is assembled, the reduction crucible is positioned in the crucible receiving recess of the crucible heater and a non-conductive washer is positioned between the base surface of the reduction crucible and the heater base, thereby blocking current flow from the heater base to the base surface.

5. The phase change system of claim 1, wherein the reduction control nozzle comprises a flow channel extending from an inlet opening to an outlet opening, wherein the outlet opening is located at the protruding outlet, and a mesh screen is positioned in the flow channel, such that fluid flowing from the inlet opening to the outlet opening traverses the mesh screen.

6. The phase change system of claim 1, wherein the reduction control nozzle comprises a nozzle body and a flow channel extending through the nozzle body from an inlet opening to an outlet opening, the nozzle body comprising a barrier portion positioned radially outward from the flow channel, and the barrier portion comprising a lipped edge.

7. The phase change system of claim 6, wherein when the reduction assembly is assembled, the lipped edge of the reduction control nozzle engages with the reduction crucible, forming a tortious interface between the reduction control nozzle and the reduction crucible.

8. The phase change system of claim 1, wherein the hot sublimation assembly further comprises a crucible heater having a crucible receiving recess terminating at a heater base.

9. The phase change system of claim 8, wherein the crucible heater of the hot sublimation assembly is a resistive heater.

10. The phase change system of claim 8, wherein the hot sublimation crucible comprises a base surface at a closed end of the hot sublimation crucible and when the hot sublimation assembly is assembled, the hot sublimation crucible is positioned in the crucible receiving recess of the crucible heater and a non-conductive washer is positioned between the base surface of the hot sublimation crucible and the heater base, thereby blocking current flow from the heater base to the base surface.

11. The phase change system of claim 1, wherein the hot sublimation crucible comprises an open end opposite a closed end, the open end including a throat comprising a throat channel extending from a throat inlet to a throat outlet and, when the hot sublimation assembly is assembled, the throat outlet extends into an activity chamber of the second modular crucible.

12. The phase change system of claim 11, wherein a mesh screen is positioned in the throat channel of the hot sublimation crucible, such that fluid flowing from the throat inlet to the throat outlet traverses the mesh screen.

13. The phase change system of claim 1, wherein the hot sublimation assembly comprises a hot sublimation control nozzle and, when assembled, the hot sublimation control nozzle extends into an activity chamber of the second modular crucible.

14. The phase change system of claim 13, wherein:
the hot sublimation control nozzle comprises a flow channel comprising an inlet opening and an outlet opening; and
a mesh screen is positioned in the flow channel, such that fluid flowing from the inlet opening to the outlet opening traverses the mesh screen.

15. The phase change system of claim 1, wherein when the cold sublimation assembly is assembled, the cold sublimation control nozzle is positioned between an open end of the collection crucible and the open end of the first modular crucible or the second modular crucible.

16. The phase change system of claim 15, wherein the first modular crucible and the second modular crucible each comprise:
a crucible body;
a closed end opposite the open end;
an activity chamber; and
an end shoulder comprising an interfacing edge terminating at the open end.

17. A method comprising:
heating a powder mixture comprising a rare earth oxide powder and a lanthanum powder in a reduction crucible, wherein heating the powder mixture reduces the rare earth oxide powder into a rare earth metal composition that collects in a first modular crucible, wherein the rare earth metal composition comprises a rare earth metal and a lanthanum metal;
positioning the first modular crucible on a crucible heater while the rare earth metal composition is disposed in the first modular crucible;
fluidly coupling the first modular crucible to a collection crucible using a sublimation control nozzle, such that the sublimation control nozzle is positioned between the first modular crucible and the collection crucible, the sublimation control nozzle comprising a flow channel; and
heating the first modular crucible using the crucible heater, thereby heating the rare earth metal composition and phase separating the rare earth metal from the lanthanum metal leaving a higher weight percentage of the of the lanthanum metal in the first modular crucible than was present in the rare earth metal composition and collecting a refined rare earth element composition in the collection crucible, wherein the refined rare earth element composition comprises a higher weight percentage of the rare earth metal than the rare earth metal composition.

18. The method of claim 17, wherein the rare earth metal is a first rare earth metal and the method further comprises irradiating the refined rare earth element composition thereby forming an irradiated composition comprising the first rare earth metal and a second rare earth metal.

19. The method of claim 18, wherein the first rare earth metal comprises lutetium and the second rare earth metal comprises ytterbium.

20. The method of claim 18, further comprising positioning the irradiated composition in a sublimation crucible and fluidly coupling the sublimation crucible to a second modular crucible.

21. The method of claim 20, further comprising:
heating the irradiated composition for a first heating period, thereby phase separating the first rare earth metal from the irradiated composition to leave a higher weight percentage of the second rare earth metal than was present in the irradiated composition; and
collecting the first rare earth metal in the second modular crucible.

22. The method of claim 21, further comprising
retaining the first rare earth metal for a waiting period to form a decayed first metal composition, wherein the waiting period is longer than the first heating period; and
subsequent to the waiting period, positioning the second modular crucible on the crucible heater while the decayed first metal composition is disposed in the second modular crucible;
fluidly coupling the second modular crucible to the collection crucible using a sublimation control nozzle, such that the sublimation control nozzle is positioned between the second modular crucible and the collection crucible;
heating the second modular crucible using the crucible heater, thereby sublimating or distilling a refined first metal composition from the decayed first metal composition for a second heating period, leaving a waste composition in the second modular crucible; and
collecting the refined first metal composition in the collection crucible.

23. The method of claim 22, further comprising irradiating the refined first metal composition thereby forming a recycled irradiated composition comprising the first rare earth metal and the second rare earth metal.

24. The method of claim 23, wherein the first rare earth metal comprises lutetium and the second rare earth metal comprises ytterbium.

25. The method of claim 23, further comprising heating the recycled irradiated composition for the first heating period, thereby phase separating the first rare earth metal from the recycled irradiated composition to leave a higher weight percentage of the second rare earth metal than was present in the recycled irradiated composition.

26. The method of claim 17, wherein, when heating the powder mixture, the reduction crucible is positioned in a reduced pressure environment.

27. The method of claim 17, wherein heating the powder mixture comprises applying heat to the reduction crucible using a crucible heater.

28. The method of claim 17, wherein the rare earth oxide powder comprises an ytterbium oxide powder and the rare earth metal comprises an ytterbium metal.

29. The method of claim 17, wherein the powder mixture is a homogeneous mixture of the rare earth oxide powder and the lanthanum powder.

30. The method of claim 17, further comprising cooling the first modular crucible while heating the powder mixture to promote collection of the rare earth metal in the first modular crucible.
